(19) United States
(12) Patent Application Publication
(10) Pub. No.: US 2025/0156639 A1
(43) Pub. Date: May 15, 2025

(54) DOCUMENT ANALYSIS AND MANAGEMENT SYSTEMS AND METHODS

(71) Applicant: SimpleO.ai, San Ramon, CA (US)

(72) Inventors: Gautam Sinha, San Ramon, CA (US); Ram Krishna Awasthi, Ghaziabad (IN)

(21) Appl. No.: 18/506,381

(22) Filed: Nov. 10, 2023

(51) Int. Cl. G06F 40/289; G06V 30/416

(52) U.S. Cl. CPC G06F 40/289; G06V 30/416

(57) ABSTRACT

Example document analysis and management systems and methods are described. In one implementation, a document is identified for processing. An artificial intelligence engine extracts information from the document and creates multiple chunks of data associated with the document. Embeddings are performed for the multiple chunks of data to create chunk embeddings, where the chunk embeddings are represented as numerical vectors. The chunk embeddings are stored in a vector database. A large language model (LLM) generates document content insights based on the multiple chunks of data and the chunk embeddings.

### TECHNICAL FIELD

The present disclosure relates to systems and methods for analyzing and managing documents, such as contracts, agreements, forms, and related items.

### BACKGROUND

Various types of documents are commonly used in business and personal situations, such as employee agreements, loan documents, work contracts, purchase and sale agreements, investment contracts, non-disclosure agreements, and the like. In many situations, the analysis, management, and negotiation of documents, such as contracts, can be time-consuming and error-prone. The time to analyze and negotiate certain documents can cost companies money or customers if the process moves slowly before finalizing the documents. Additionally, if people are not careful when reviewing documents, the final versions of the documents may contain errors or unintended statements or requirements.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 illustrates an embodiment of a process flow for ingesting and processing documents.

FIG. 3 illustrates an embodiment of a process flow for generating a playbook.

FIG. 4 illustrates an embodiment of a process flow for generating alerts and triggers.

FIG. 5 illustrates an embodiment of a process flow for integrating with various systems and APIs (application programming interfaces).

FIG. 6 is a block diagram illustrating an embodiment of an artificial intelligence engine.

FIG. 7 is a flow diagram illustrating an embodiment of a method for ingesting and processing documents.

FIG. 8 is a flow diagram illustrating an embodiment of a method for answering a question.

FIG. 9 is a flow diagram illustrating an embodiment of a method for generating a playbook.

FIG. 10 is a flow diagram illustrating an embodiment of a method for generating alerts and triggers.

FIG. 11 illustrates an example block diagram of a computing device.

### DETAILED DESCRIPTION

The document analysis and management systems and methods discussed herein help individuals, companies, and enterprises manage and analyze multiple documents, such as contracts. For example, the systems and methods described herein may include an artificial intelligence engine that manages, summarizes, and analyzes various types of documents. The management, summarization, and analysis may identify potential insights associated with the document, inconsistencies in the document, inconsistencies with other similar documents, legal issues, potential risks, potential opportunities, obligations, milestones, deadlines, and the like. As discussed herein, the document analysis and management systems and methods may improve document consistency, improve document validity, accelerate approval of the document, avoid document errors, improving post-approval management of activities associated with the document, and the like.

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

At least some embodiments of the disclosure are directed to computer program products comprising such logic (e.g., in the form of software) stored on any computer useable medium. Such software, when executed in one or more data processing devices, causes a device to operate as described herein.

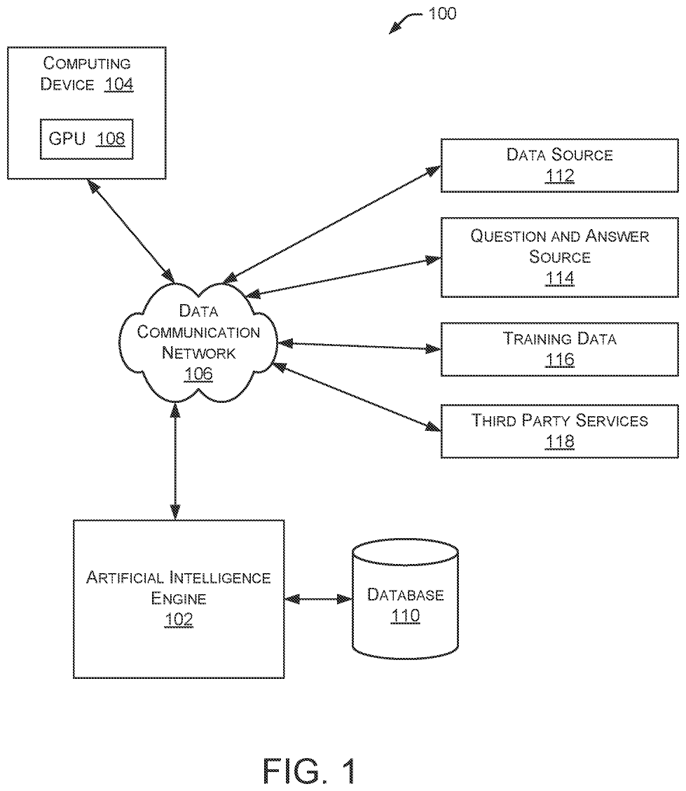

FIG. 1 is a block diagram illustrating an environment 100 within which an example embodiment may be implemented. As shown in FIG. 1, an artificial intelligence engine 102 is coupled to a data communication network 106 and a database 110. Environment 100 also includes one or more computing device 104 where each computing device 104 includes one or more graphics processing units (GPUs) 108. Computing device 104 may be a server or other type of device capable of communicating with artificial intelligence engine 102 via data communication network 106. For example, computing device 104 may identify, store, manage, or arrange various documents for the benefit of artificial intelligence engine 102 or other systems. Each of the GPUs 108 in computing device 104 perform various processing operations, such as operations assigned or managed by artificial intelligence engine 102. Each of the GPUs 108 may also perform any of the other operations and functions discussed herein. In some embodiments, database 110 stores various data used to perform the functions described herein. For example, database 110 may include data associated with any number of documents, the results of analyzing or managing documents, the results of the functions and operations performed by artificial intelligence 102, and the like.

Environment 100 further includes a data source 112, a question and answer source 114, training data 116, and one or more third party services 118 as described herein. As shown in FIG. 1, artificial intelligence engine 102 may communicate with any of data source 112, question and answer source 114, training data 116, and third party services 118. In some embodiments, data source 112 may include any data repository, data storage service, communication service, or other system capable of storing or managing data, such as documents or related information. In some examples, question and answer source 114 may include various questions and answers related to documents, document analysis, document management, and the like. Training data 116 may include various types of data used to train artificial intelligence engine 102, including any number of components in artificial intelligence engine 102. Third party services 118 may include various services related to document analysis, document management, and the like that may be used (or accessed) by artificial intelligence engine 102, computing device 104, and other systems or devices. For example, third party services 118 may include OCR (optical character recognition) services, open source vector database services, open source models and related services (such as embedding models and embedding model services), and the like.

Data communication network 106 includes any type of network topology using any communication protocol. Additionally, data communication network 106 may include a combination of two or more communication networks. In some embodiments, data communication network 106 includes a cellular communication network, the Internet, a local area network, a wide area network, or any other communication network. In environment 100, data communication network 106 allows communication between artificial intelligence engine 102, computing device 104, and any number of other systems and services, such as data source 112, question and answer source 114, training data 116, and third party services 118.

Although one computing device 104 is shown in FIG. 1, particular embodiments may include any number of computing devices 104 that can each communicate with any of the components or systems illustrated in FIG. 1. Further, any number of data sources 112, question and answer sources 114, training data 116, and third party services 118 may be included in particular embodiments and configured to communicate with any of the components or systems illustrated in FIG. 1.

It will be appreciated that the embodiment of FIG. 1 is given by way of example only. Other embodiments may include fewer or additional components without departing from the scope of the disclosure. Additionally, illustrated components may be combined or included within other components without limitation.

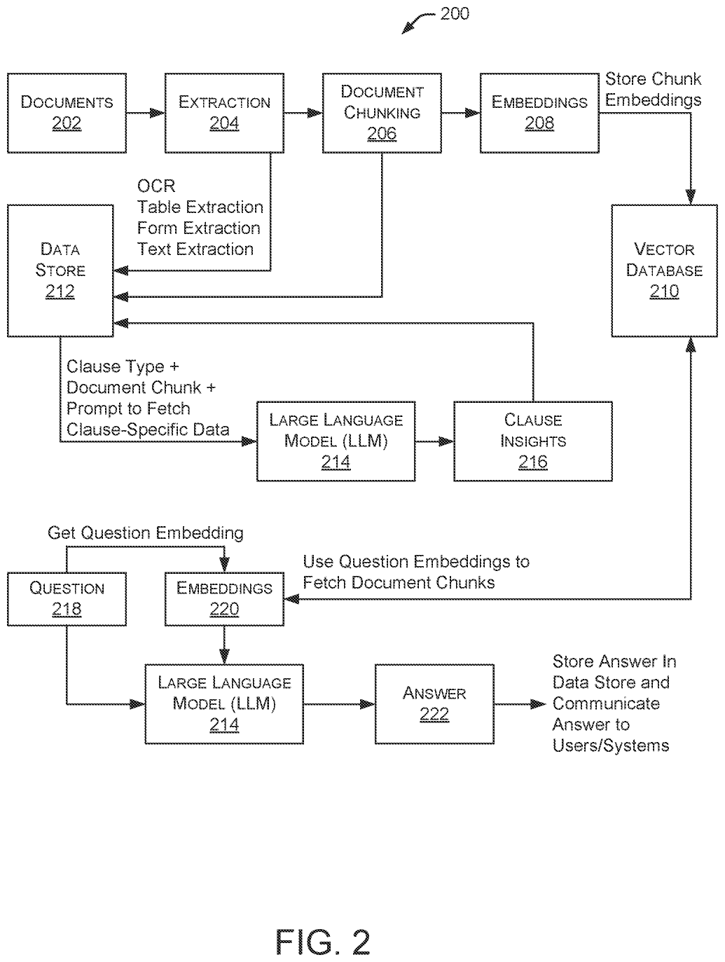

FIG. 2 illustrates an embodiment of a process flow 200 for ingesting and processing documents. Any number of documents 202 may be received by process flow 200. These documents may include contracts, agreements, or any other type of document of any length. Each document 202 goes through an extraction process 204, which may include extracting different sections or portions of a document. For example, extraction process 204 may include performing OCR (optical character recognition) on all or part of document 202. In some embodiments, OCR is a process that converts an image of text into a machine-readable text format. Additionally, extraction process 204 may include extracting tables from document 202, extracting forms from document 202, extracting images from document 202, extracting text from document 202, and the like.

In some embodiments, extraction process 204 may vary depending on the type of document. For example, prior to implementing extraction process 204, the document may be classified as a particular type (or category) of document, such as a contract, an NDA (non-disclosure agreement), an MSA (master service agreement), and the like. In some implementations, the classification of a particular document uses a classification model to analyze and classify each document being processed. The classification model may be trained on any number of example documents with a known document type. Based on the classification of the document, extraction process 204 may extract different types of information that are relevant to the classification of the document. For example, if the document is classified as an NDA, the extraction process 204 may focus in extracting information related to confidentiality requirements, exceptions to confidentiality terms, rights of the parties to the NDA, and the like. In another example, if the document is classified as an MSA, the extraction process 204 may focus on payment terms, performance obligations of the parties, termination options, and the like. In some embodiments, at least a portion of the items extracted by process 204 are stored in a data store 212 for future access or future reference.

The process flow 200 further includes document chunking 206 that breaks document 202 into multiple chunks. In some embodiments, each of the multiple chunks has a similar size, such as a similar number of characters in each chunk. The number of characters in each chunk may be tested and optimized for use with the systems and methods discussed herein. In some implementations, the size of each chunk (e.g., the number of characters in each chunk) are similar for all document classifications. For example, an NDA document and an MSA document may be divided into chunks of similar sizes. The multiple chunks created by document chunking 206 are stored in data store 212 and communicated to an embeddings process 208.

Embeddings process 208 receives the multiple chunks and creates an embedding associated with each chunk. In some embodiments, embeddings represent data (e.g., document data) in a manner that can easily be understood by computing systems. Certain embeddings may compress the data in a manner that maintains the important information while discarding unimportant information. In certain implementations, each chunk may have specific word embeddings associated with the chunk. The word embeddings may be represented as numerical vectors, as discussed herein. For example, the numerical vectors may be created by providing each chunk to an embedding model or similar system that produces multi-dimensional arrays of numbers. The multiple embeddings created by process 208 are stored, for example, in a vector database 210.

In some embodiments, vector database 210 includes vectors that are the mathematical representation of text in high dimensional space. The vectors may represent semantic relationships between two words or text strings, such as “cat” and “dog” that are related as animals. The systems and methods described herein may use these vectors for semantic search (e.g., to find similarity between two text items). In some embodiments, the vectors are extracted from the embeddings created by embeddings process 208 using a variety of models, such as BERT (Bidirectional Encoder Representations from Transformer). In some implementations, each word (or text item) has a unique value in multiple dimensions. For example, vectors for “dog” and “cat” may include:
dog: (0.5, 0.3, −0.1, 0.7, 0.9, −0.4, 0.2, −0.5, 0.6, −0.2)
cat: (0.4, 0.2, −0.3, 0.6, 0.8, −0.5, 0.1, −0.4, 0.7, −0.1)

As shown in FIG. 2, data from data store 212 may be provided to a large language model (LLM) 214 for processing. In some embodiments, LLM 214 may be part of artificial intelligence engine 102, discussed herein. The data provided to LLM 214 from data store 212 may include, for example, a document chunk, a clause type associated with the document chunk or other data, clause-specific data associated with a particular document chunk, a prompt to fetch and/or analyze particular data, and the like. As discussed herein, LLM 214 may perform various operations and functions related to document analysis and document management. In some embodiments, LLM 214 may use a pre-trained model as a base. The pre-trained model is then fine-tuned with relevant data to enrich its knowledge. For example, the pre-trained model can be fine-tuned with specific knowledge related to documents, document analysis, and document management. This fine-tuning of LLM 214 increases its knowledge and intelligence regarding document analysis and document management tasks. In some embodiments, the fine-tuning may be an ongoing process that continually improves the accuracy and skills of LLM 214. In particular implementations, LLM 214 contains multiple layers that work together to process the input data (e.g., text) and generate one or more outputs. The fine-tuning of LLM 214 may be accomplished by adding another layer to LLM 214. The added layer may include new types of data, new types of documents, new types of clauses, and the like that LLM 214 has not previously seen or processed. This added layer provides new learning for LLM 214 to improve its operation when processing various types of documents and associated data. In various embodiments, LLM 214 may be part of artificial intelligence engine 102 or part of a separate system that's coupled to artificial intelligence engine 102 or other systems discussed herein.

As shown in FIG. 2, the output of LLM 214 may be provided to a clause insights process 216 that can analyze and identify various insights in a document, a document chunk, a clause within a document, and the like. As discussed herein, many documents, such as contracts, are a collection of multiple clauses. The clauses may be grouped into clause types based on the name of a category associated with each clause, such as indemnity clauses, confidentiality clauses, and the like. In some embodiments, the systems and methods described herein may identify paragraphs, sentences, or other text segments that contain relevant information about a clause to give relevant answers to one or more questions or queries. These identified paragraphs, sentences, or other text segments may be referred to as “document chunks.” In some implementations,

In some implementations, prompts are used by the described systems and methods. For example, prompts may be well-formed natural language questions augmented with contextual information and a format of the output. In some examples, to extract parties involved in a particular contract, there may be a question asking about the details of the parties involved with their address details and augmented data.

Clause insights process 216 may include the relevant key information associated with any clause. For example, a terms clause may give details regarding the duration, expiration date and the like associated with the contract. In another example, a limited liability clause may give details regarding the maximum liability, exemptions to liability, and the like. Example clause insights may include, “the next payment of $250 is due on March 21,” “John is late in sending his approval of the contract extension,” and the like. In some implementations, the clause insights generated by clause insights process 216 may be stored in data store 212 for future reference, such as responding to a user's question about the particular clause insight or related query.

In some embodiments, process flow 200 may receive a question 218 from a user, a computing system, or any other system or method. Question 218 may include a question related one or more documents, one or more document chunks, one or more document clauses, and the like. For example, question 218 may include, “When is the next payment due on the Acme widget contract?” The question is provided to an embeddings process 220, which receives the question and creates one or more question embeddings associated with the question. In some embodiments, the question embeddings are used to fetch relevant document chunks from data store 212 and/or vector database 210.

Question 218 may also be provided to LLM 214, which generates an answer 222 to question 218 based on one or more of question 218, embeddings 220, relevant document chunks, and the like. LLM 214 shown in the lower portion of FIG. 2 is the same as LLM 214 shown in the upper portion of FIG. 2 and discussed above with respect to clause insights process 216. Using the previously discussed example, the answer 222 may include an answer to question 218, such as, “The next payment on the Acme widget contract is due on Nov. 22, 2023.” In some embodiments, answer 222 may be stored in data store 212 and/or communicated to one or more users and/or systems. For example, the one or more users and/or systems may include users or systems that submitted or generated question 218. Additionally, the one or more users and/or systems may include users or systems that are likely to be interested in answer 222 (e.g., due to related work activities, contract management activities, and the like). By storing answer 222 in data store 212, the answer is readily available for answering the same question 218 (or a related question) in the future.

In some embodiments, the described systems and methods may perform one or more verifications to determine the accuracy of the output generated by LLM 214 and other systems and methods discussed herein. For example, the accuracy of an initial output from LLM 214 may be verified by a second LLM or other system. In some embodiments, the second LLM may use a different model than the model used by LLM 214 to generate the initial output. If the initial output is verified, then it may continue to be used by the described systems and methods. However, if the initial output is not verified (e.g., not accurate), the initial output may be discarded. Additionally, if the initial output is not verified, inconsistencies between the initial output and the verification process may be flagged to improve the future results generated by LLM 214. In some implementations, the initial output is also verified against data in a playbook, as discussed herein. In some examples, if the initial output is verified by the output of the second LLM, an additional verification may be performed by a human, such as a lawyer or other expert on the topic of the document being verified.

In particular embodiments, the described systems and methods may track data associated with each query (or prompt) sent to LLM 214 as well as the results generated by LLM 214. As LLMs improve over time (e.g., through learning or fine-tuning), the results generated by an LLM based on the same query may change. For example, a query “What are the preferred payment terms for a payment clause?” may generate a particular result at the current time based on the knowledge and data used by LLM 214 on the current date. As LLM 214 learns and fine-tunes its model, the same query may produce a different result because LLM 214 has “learned” and improved its model and/or processes. In some situations, it may be desirable to recreate a query presented at a past date and verify the results that would have been created on the past date (which may be different than the results generated by the same query today). To support recreating past query results, the systems and methods described herein may track various data and results at different dates and times. For example, the described systems and methods may track an API version, an LLM model version, a particular query, and the like for each result generated. Thus, the systems and methods can use this tracked data to recreate past query results to confirm (or recreate) the results of a past query.

In some embodiments, the systems and methods described herein include a smart repository. The smart repository may be a sophisticated and artificial intelligence-enabled system for analyzing and managing contracts and other documents. The smart repository leverages artificial intelligence, including LLM 214 and natural language processing, to extract valuable insights from contracts and other documents. This approach makes the contract analysis and management process more efficient and effective.

In some embodiments, the smart repository may include multiple contract-related features, such as:
Automated Data Extraction—Utilizes artificial intelligence to automatically extract relevant data from contracts, such as key terms, clauses, dates, and parties.
Clause Analysis—Analyzes individual clauses within contracts to provide insights into legal and business implications, potential risks, and opportunities.
Risk Assessment—Identifies and quantifies potential risks and obligations associated with specific clauses or terms in contracts.
Obligation Management—Monitors contract obligations and milestones to ensure compliance and timely execution.
Contract Comparison—Compares multiple contracts to highlight differences, similarities, and potential inconsistencies with respect to stored and approved playbooks.
Contract Visualization—Provides visual representations of contract data, relationships, and timelines.
Search and Retrieval—Enables quick and accurate contract search using natural language queries and filters.
Alerts and Notifications—Sends automated alerts for contract renewals, expirations, or other critical events.
Integration—Seamlessly integrates with other software systems like customer relationship management (CRM), enterprise resource planning (ERP), and legal management tools.

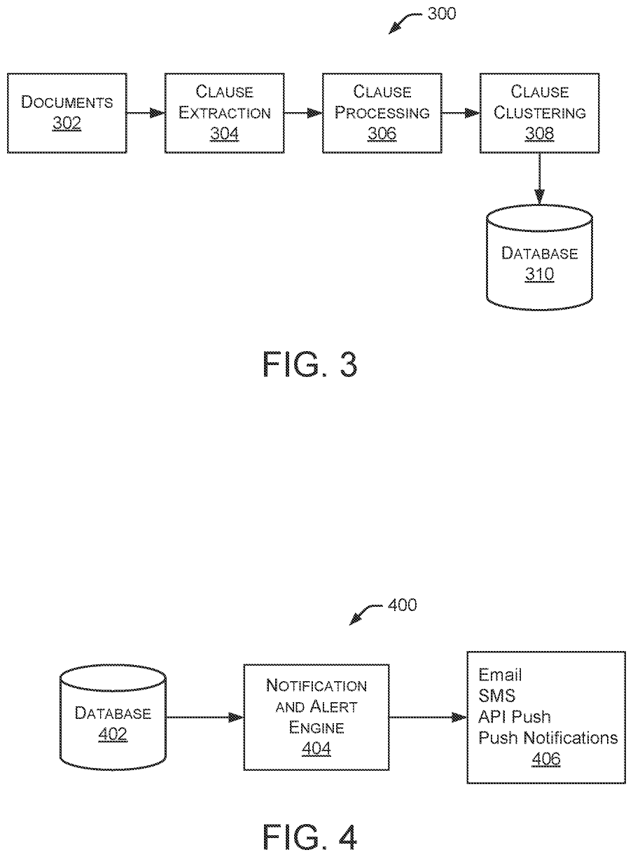

FIG. 3 illustrates an embodiment of a process flow 300 for generating a playbook. In some embodiments, a playbook refers to a structured and predefined set of clauses and/or obligations that are used as best practices in a particular organization. The playbook may serve as a strategic resource that organizations use to standardize and minimize their contract-related risks. Using the playbook may allow an organization to identify potential inconsistencies in a contract before signing. In some implementations, process flow 300 may receive any number of documents 302. These documents may include contracts, agreements, or any other type of document of any length. Each document 302 goes through a clause extraction 304 process, which may include extracting different clauses or other portions of a particular document 302. For example, clause extraction 304 may include identifying clauses contained in a particular contract. In a specific implementation, a particular playbook may contain clauses used by the organization in particular types of contracts, such as a payment-related clauses. In one example, the systems and methods discussed herein may extract and analyze multiple payment terms clauses in multiple documents previously approved by the organization. The described systems and methods can identify commonly-used language and payment terms clauses used by the organization. This commonly-used language and payment terms clauses are added to the organization's playbook for future use when analyzing or generating documents that include payment terms clauses.

Process flow 300 continues by processing 306 one or more clauses, such as the analysis of multiple clauses used in multiple documents that were previously approved and/or used by the organization. In some embodiments, process flow 300 further includes a clause clustering process 308 that groups together similar or related clauses. In the above example, clause clustering process 308 may group together multiple payment terms clauses for each type of document used by the organization. In some implementations, process flow 300 may include storing document data, clause extraction data, clause processing data, clause clustering data, and other data in a database 310 for future access or future reference.

In some embodiments, the described systems and methods generate multiple playbooks for each organization. Each of the multiple playbooks may include knowledge and examples of clauses that are acceptable for particular types of documents associated with each playbook. For example, an organization may have separate playbooks for NDAs, MSAs, and other types of documents used by the organization. The organization's NDA playbook may contain the text associated with multiple clauses that have been used by (e.g., approved) the organization in previous NDAs. In some embodiments, an organization's multiple playbooks may be used to generate new contracts, evaluate proposed contracts, and the like based on approved clause language contained in a particular playbook for the contract or document being generated or evaluated.

FIG. 4 illustrates an embodiment of a process flow 400 for generating alerts and triggers. In some embodiments, the triggers may be “actionable triggers” that refer to specific events or conditions identified within a contract that prompt a predefined action or response from relevant parties. These triggers may be established to ensure that important contractual obligations, deadlines, or milestones are met in a timely and efficient manner. By detecting and acting upon these triggers, organizations can effectively manage their contracts, reduce risks, and optimize outcomes. For example, the notification and alert engine discussed below may send automated alerts for contract renewals, expirations, or other critical events.

In some embodiments, process flow 400 may access documents and other data from a database 402. These documents accessed from database 402 may include contracts, agreements, or any other type of document of any length. The other data accessed from database 402 may include notification triggers, alert triggers, metadata, document relationships, document characteristics, and the like. A notification and alert engine 404 receives or accesses data from database 402 to determine whether to generate one or more notifications or alerts. For example, if a notification is to be generated in response to an upcoming contract event (e.g., a payment event, performance of an activity related to the contract, and the like), notification and alert engine 404 may generate the notification and communicate the notification to one or more users, systems, and the like. Similarly, if an alert is to be generated in response to a particular event related to a contract (such as a contract deadline has passed without required activity), notification and alert engine 404 may generate an alert that warns a user or system that the required activity has not been performed. The alert may be communicated to any number of users and/or systems that are associated with the contract or otherwise need to be alerted to the failure to perform the required activity. Process flow 400 continues by communicating 406 the notification or alert to one or more users and/or systems. In some embodiments, the notification or alert can be communicated via an email message, an SMS (short message service) message, an API (application programming interface), push message, push notification messages, and the like.

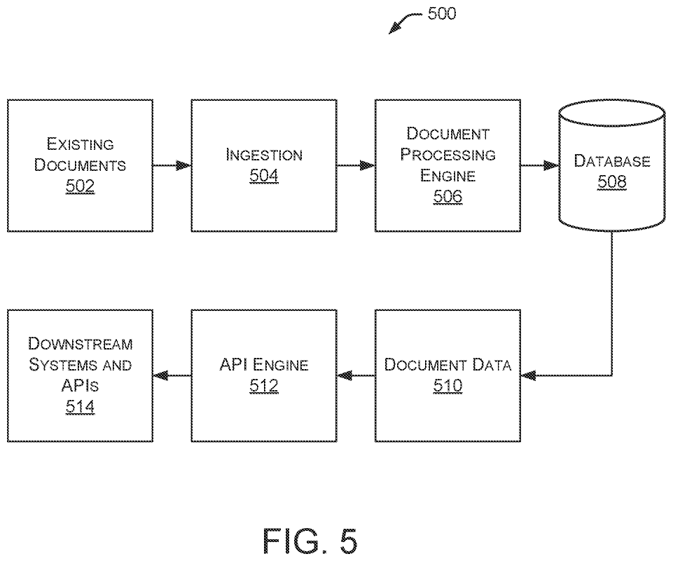

FIG. 5 illustrates an embodiment of a process flow 500 for integrating with various systems and APIs. As shown in FIG. 5, existing documents 502 (e.g., contracts) are provided to an ingestion process 504, which ingests documents 502 and may identify various items or sections in each document. In some embodiments, the ingestion process 504 is similar to the ingestion process discussed herein with respect to FIG. 2. A document processing engine 506 performs various operations, such as extracting items (e.g., clauses) from documents 502, breaking documents 502 into chunks, and the like, as discussed herein (e.g., with respect to FIG. 2). The document processing engine 502 may obtain details from various clauses, chunks, and sections of each document. The results of the operations performed by document processing engine 506 are stored in a database 508 for future reference or future access. In some embodiments, certain data entries in database 508 are provided to a document data process 510 which may perform various functions on the data entries accessed from database 508. An output from document data process 510 is provided to an API engine 512, which may process the information received from document data process 510.

In some embodiments, API engine 512 may integrate with any number of departments within an organization, such as human resources, financial, sales, engineering, and the like. This integration supports the sharing of data with all appropriate departments within a company or other organization. An output from API engine 512 may be provided to any number of downstream 514 systems, APIs, and the like. For example, API engine 512 may provide documents and document-related data to other enterprise systems or third-party systems, such as partner systems, client systems, and the like. In some implementations, process flow 500 may create an API layer to integrate with downstream systems using one or more APIs.

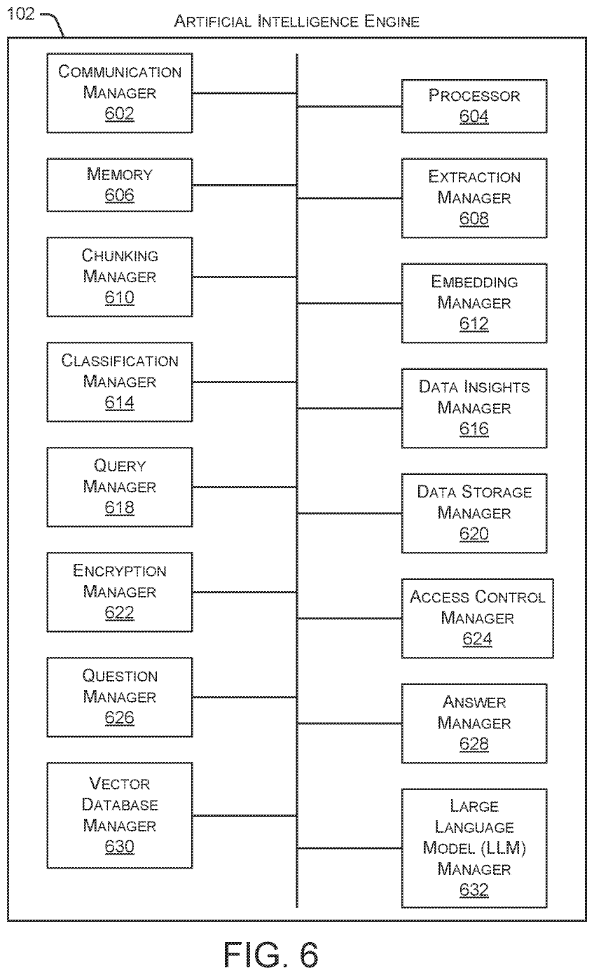

FIG. 6 is a block diagram illustrating an embodiment of artificial intelligence engine 102. As shown in FIG. 6, artificial intelligence engine 102 may include a communication manager 602, a processor 604, and a memory 606. Communication module 602 allows artificial intelligence engine 102 to communicate with other systems, such as computing device 104 shown in FIG. 1, and the like. Processor 604 executes various instructions to perform the functionality provided by artificial intelligence engine 102, as discussed herein. Memory 606 stores these instructions as well as other data used by processor 604 and other modules and components contained in artificial intelligence engine 102.

Additionally, artificial intelligence engine 102 includes an extraction manager 608 that manages various data and document extraction processes, such as those discussed herein. A chunking manager 610 is capable of managing document chunking and related operations described herein. Artificial intelligence engine 102 may also include an embedding manager 612 that may oversee embedding processes discussed herein that are performed during operation of the described systems and methods.

Some embodiments of artificial intelligence engine 102 further include a classification manager 614 capable of classifying documents, portions of documents, clauses within documents, and the like, as discussed herein. A data insights manager 616 may manage processes related to identifying insights in a document, insights related to portions of a document, and the like. Artificial intelligence engine 102 may also include a query manager 618 that manages one or more queries or questions as described herein.

Artificial intelligence engine 102 may also include a data storage manager 620 and an encryption manager 622. Data storage manager 620 may manage the storage and retrieval of data from a database or data storage device, as discussed herein. In some embodiments, encryption manager 622 may manage the encryption and/or decryption of data, such as data stored in a database, data storage device, and the like. An access control manager 624 may control access to documents, data, systems, procedures, and the like by a user or a system, as discussed herein.

Artificial intelligence engine 102 further includes a question manager 626 and an answer manager 628. In some embodiments, question manager 626 may manage the collection and processing of questions related to documents, portions of documents, and the like. Additionally, answer manager 628 may manage the processing and distribution of answers to the received questions, as discussed herein.

Artificial intelligence engine 102 may also include a vector database manager 630 that is capable of managing various vector database functions, such as those discussed herein. Artificial intelligence engine 102 also includes an LLM manager 632 that may oversee various operations performed by an LLM, such as LLM 214 discussed herein with respect to FIG. 2.

Although particular components, modules, and systems are shown in FIG. 6 as part of artificial intelligence engine 102, alternate embodiments may contain additional components, modules, and systems not shown in FIG. 6. Further, some embodiments may not contain one or more of the components, modules, and systems shown in FIG. 6.

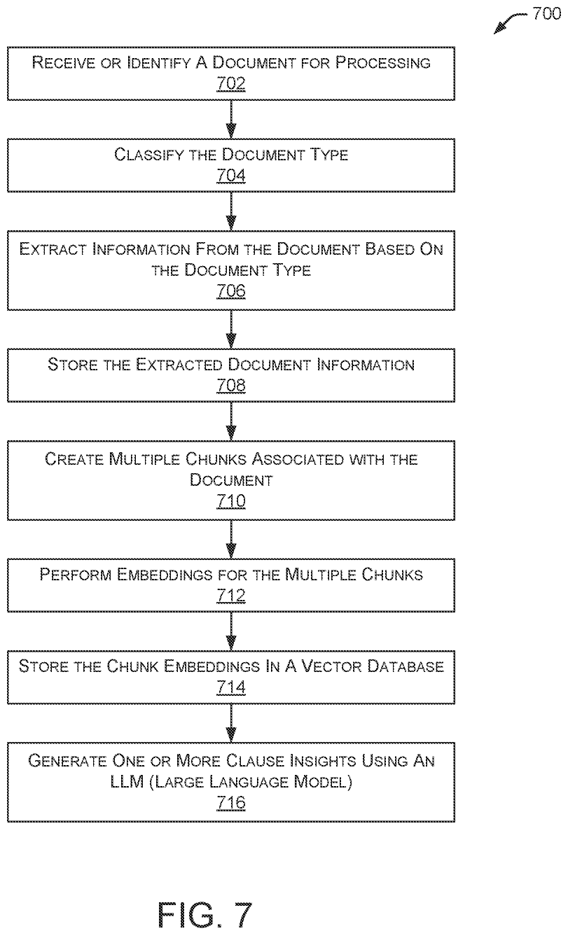

FIG. 7 is a flow diagram illustrating an embodiment of a method 700 for ingesting and processing documents. Additional details regarding ingesting and processing documents are provided, for example, with respect to the discussion of FIG. 2.

Initially, method 700 receives or identifies 702 a document for processing. For example, the document may be received 702 from a data storage system or a user requesting processing of the document. The method continues by classifying 704 the document type. In some embodiments, the document type may include a contract, an NDA, an MSA, and the like. Method 700 then extracts 706 information from the document based on the document type classified at 704. The information extracted information may be text information, table information, form information, and the like. In some embodiments, text may be extracted from the document using OCR or similar techniques. The extracted information from the document is then stored 708 for future reference or access.

Method 700 continues by creating 710 multiple chunks associated with the document, as discussed herein. The method then performs embeddings 712 for the multiple chunks to create an embedding associated with each chunk. In some embodiments, each chunk may have specific word embeddings associated with the chunk. The word embeddings may be represented as numerical vectors, as discussed herein. For example, the numerical vectors may be mathematical representations of text in a high dimensional space. The chunk embeddings (e.g., numerical vectors) are then stored 714 in a vector database. Method 700 then generates 716 one or more clause insights using an LLM, such as LLM 214 discussed herein. The clause insights may be based on a document, a document chunk, a clause within a document, and the like. Particular clause insights may include relevant key information associated with one or more clauses, such as a contract duration, expiration, and the like.

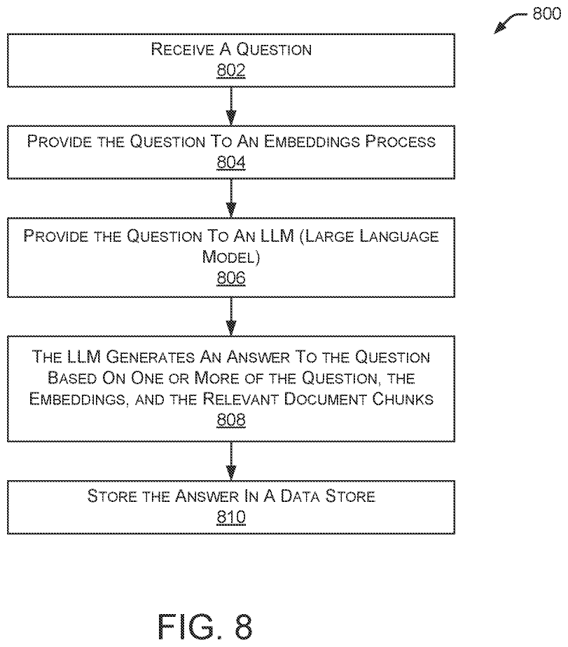

FIG. 8 is a flow diagram illustrating an embodiment of a method 800 for answering a question. Additional details regarding answering a question are provided, for example, with respect to the discussion of FIG. 2.

Initially, method 800 receives 802 a question from a user, a computing system, or any other system or method. The question may be related to one or more documents, document chunks, document clauses, and the like. The method provides 804 the question to an embeddings process that may create one or more question embeddings associated with the question. In some embodiments, the question embeddings are used to fetch relevant document chunks from a data store.

Method 800 continues by providing 806 the question to an LLM, such as LLM 214 discussed with respect to FIG. 2. The LLM generates 808 an answer to the question based on one or more of the question, the question embeddings, relevant data chunks, and the like. The method then stores 810 the answer in a data store for future reference or access.

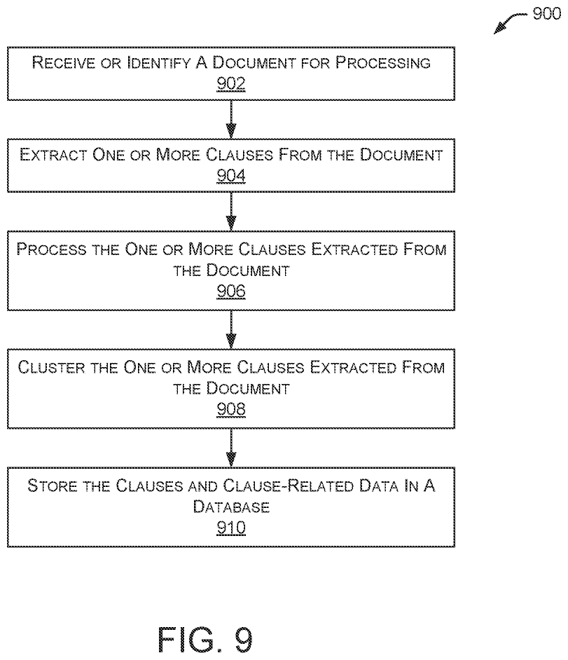

FIG. 9 is a flow diagram illustrating an embodiment of a method 900 for generating a playbook. As discussed herein, a playbook may refer to a structured and predefined set of clauses and/or obligations that are used as best practices in a particular organization. Additional details regarding generating a playbook are provided, for example, with respect to the discussion of FIG. 3.

Initially, method 900 receives or identifies 902 a document for processing. The method extracts 904 one or more clauses from the document. Extracting 904 clauses from the document may include identifying any number of clauses in the document. Method 900 continues by processing 906 the one or more clauses extracted from the document. In some embodiments, processing 906 may include analyzing multiple clauses used in multiple documents that were previously approved or used by the organization.

Method 900 continues by clustering 908 the one or more clauses extracted from the document. For example, clustering 908 may include grouping together similar or related clauses. The method then stores 910 the clauses and the clause-related data in a database or other storage mechanism for future reference or access.

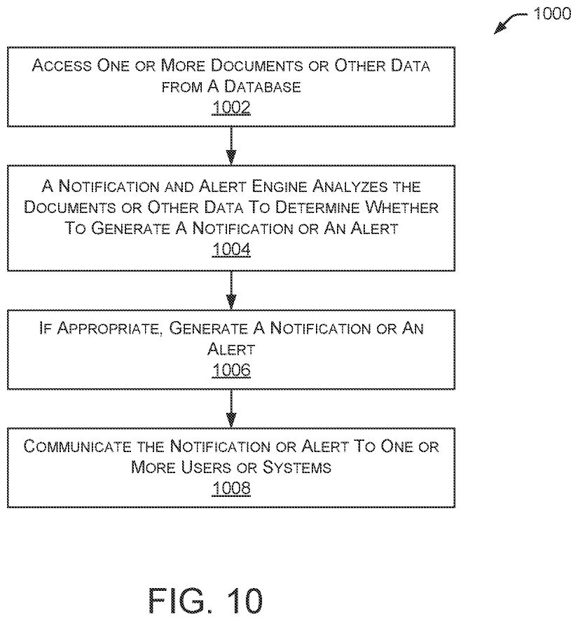

FIG. 10 is a flow diagram illustrating an embodiment of a method 1000 for generating alerts and triggers. Additional details regarding generating alerts and triggers are provided, for example, with respect to the discussion of FIG. 4.

Initially, method 1000 accesses 1002 one or more documents or other data from a database. At 1004, a notification and alert engine analyzes the documents or other data to determine whether to generate a notification or an alert. Example notifications or alerts may be associated with upcoming contract events, such as payment events, performing an activity related to the contract, and the like.

Method 1000 continues by generating 1006 a notification or an alert if appropriate (e.g., if determined by the notification and alert engine). For example, the notification or alert may be associated with an upcoming deadline, an overdue deadline, and the like. The method then communicates 1008 the notification or alert to one or more users or systems. The notification or alert may be communicated to any number of users or systems that need to receive the notification or alert. In some embodiments, the notification or alert may be communicated by email, SMS message, an API, a push message, a push notification message, and the like.

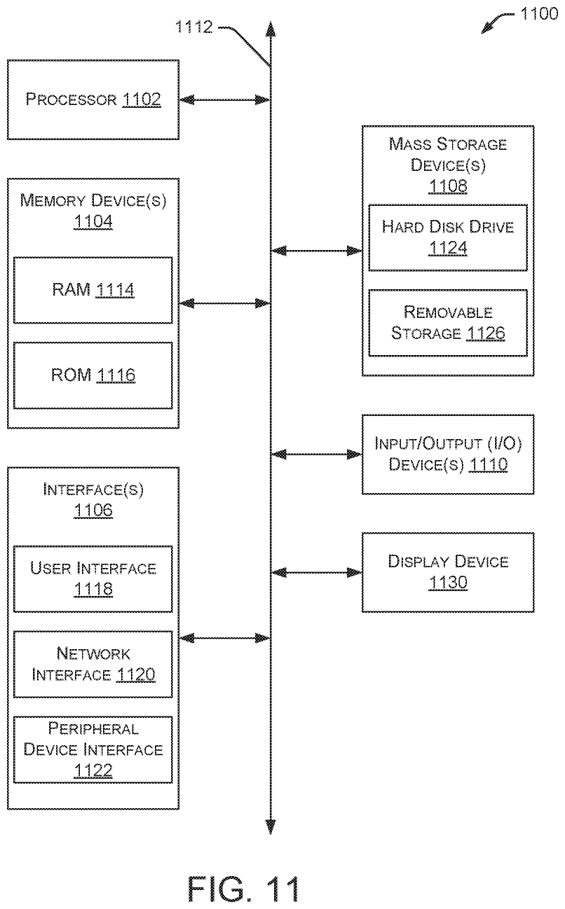

FIG. 11 illustrates an example block diagram of a computing device 1100. Computing device 1100 may be used to perform various procedures, such as those discussed herein. For example, computing device 1100 may perform any of the functions or methods of the computing devices and systems discussed herein, such as the Behavior Change Engine. Computing device 1100 can further execute one or more application programs, such as the application programs or functionality described herein. Computing device 1100 can be any of a wide variety of computing devices, such as a desktop computer, a notebook computer, a server computer, a handheld computer, tablet computer, a wearable device, and the like.

Computing device 1100 includes one or more processor(s) 1102, one or more memory device(s) 1104, one or more interface(s) 1106, one or more mass storage device(s) 1108, one or more Input/Output (I/O) device(s) 1110, and a display device 1130 all of which are coupled to a bus 1112. Processor(s) 1102 include one or more processors or controllers that execute instructions stored in memory device(s) 1104 and/or mass storage device(s) 1108. Processor(s) 1102 may also include various types of computer-readable media, such as cache memory.

Memory device(s) 1104 include various computer-readable media, such as volatile memory (e.g., random access memory (RAM) 1114) and/or nonvolatile memory (e.g., read-only memory (ROM) 1116). Memory device(s) 1104 may also include rewritable ROM, such as Flash memory.

Mass storage device(s) 1108 include various computer readable media, such as magnetic tapes, magnetic disks, optical disks, solid-state memory (e.g., Flash memory), and so forth. As shown in FIG. 11, a particular mass storage device is a hard disk drive 1124. Various drives may also be included in mass storage device(s) 1108 to enable reading from and/or writing to the various computer readable media. Mass storage device(s) 1108 include removable media 1126 and/or non-removable media.

I/O device(s) 1110 include various devices that allow data and/or other information to be input to or retrieved from computing device 1100. Example I/O device(s) 1110 include cursor control devices, keyboards, keypads, microphones, monitors or other display devices, speakers, printers, network interface cards, modems, and the like.

Display device 1130 includes any type of device capable of displaying information to one or more users of computing device 1100. Examples of display device 1130 include a monitor, display terminal, video projection device, and the like.

Interface(s) 1106 include various interfaces that allow computing device 1100 to interact with other systems, devices, or computing environments. Example interface(s) 1106 may include any number of different network interfaces 1120, such as interfaces to local area networks (LANs), wide area networks (WANs), wireless networks, and the Internet. Other interface(s) include user interface 1118 and peripheral device interface 1122. The interface(s) 1106 may also include one or more user interface elements 1118. The interface(s) 1106 may also include one or more peripheral interfaces such as interfaces for printers, pointing devices (mice, track pad, or any suitable user interface now known to those of ordinary skill in the field, or later discovered), keyboards, and the like.

Bus 1112 allows processor(s) 1102, memory device(s) 1104, interface(s) 1106, mass storage device(s) 1108, and I/O device(s) 1110 to communicate with one another, as well as other devices or components coupled to bus 1112. Bus 1112 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 1100, and are executed by processor(s) 1102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
identifying a document for processing;
extracting, by an artificial intelligence engine, information from the document;
creating, by an artificial intelligence engine, a plurality of chunks of data associated with the document;
performing embeddings for the plurality of chunks of data to create chunk embeddings, wherein the chunk embeddings are represented as numerical vectors;
storing the chunk embeddings in a vector database; and
generating, by a Large Language Model (LLM), a plurality of document content insights based on the plurality of chunks of data and the chunk embeddings.

2. The method of claim 1, wherein extracting information from the document includes performing optical character recognition on the document.

3. The method of claim 2, further comprising storing the extracted information from the document and the results of performing optical character recognition on the document in a data store.

4. The method of claim 1, wherein the plurality of document content insights include at least one of legal insights, potential risks, potential opportunities, document obligations, document milestones, document deadlines, differences with other documents, differences with clauses in other documents, and suggested changes to the document.

5. The method of claim 1, wherein the identified document is a contract that includes a plurality of clauses.

6. The method of claim 5, wherein generating document content insights by the LLM includes analyzing the plurality of clauses.

7. The method of claim 5, wherein generating document content insights by the LLM includes analyzing the plurality of clauses and at least one playbook.

8. The method of claim 7, wherein the at least one playbook includes a structured and predefined set of clauses that are approved by a particular organization.

9. The method of claim 5, wherein generating document content insights by the LLM includes analyzing the plurality of clauses to identify a plurality of activities associated with the plurality of clauses.

10. The method of claim 5, further comprising clustering the plurality of clauses to generate a playbook.

11. The method of claim 1, wherein the content insights may include at least one of inconsistencies in the document, inconsistencies with other similar documents, legal issues, potential risks, potential opportunities, obligations, milestones, or deadlines.

12. The method of claim 1, further comprising:
generating a notification associated with at least one of the content insights; and
communicating the notification to at least one user or system associated with the content insight.

13. An apparatus comprising:
a storage device; and
an artificial intelligence engine coupled to the storage device and configured to:
identify a document for processing;
extract information from the document;
create a plurality of chunks of data associated with the document;
perform embeddings for the plurality of chunks of data to create chunk embeddings, wherein the chunk embeddings are represented as numerical vectors;
store the chunk embeddings in a vector database; and
generate a plurality of document content insights based on the plurality of chunks of data and the chunk embeddings.

14. The apparatus of claim 13, wherein the artificial intelligence engine is further configured to store the plurality of document content insights in the storage device.

15. The apparatus of claim 13, wherein the plurality of document content insights include at least one of legal insights, potential risks, potential opportunities, document obligations, document milestones, document deadlines, differences with other documents, differences with clauses in other documents, and suggested changes to the document.

16. The apparatus of claim 13, wherein the identified document is a contract that includes a plurality of clauses, and wherein the plurality of document content insights are generated by analyzing the plurality of clauses.

17. The apparatus of claim 16, wherein the plurality of document content insights include at least one activity associated with the plurality of clauses.

18. One or more non-transitory computer-readable media storing instructions that, when executed, cause one or more processors to perform operations comprising:
identifying a document for processing;
extracting information from the document;
creating a plurality of chunks of data associated with the document;
performing embeddings for the plurality of chunks of data to create chunk embeddings, wherein the chunk embeddings are represented as numerical vectors;
storing the chunk embeddings in a vector database; and
generating a plurality of document content insights based on the plurality of chunks of data and the chunk embeddings.

19. The one or more non-transitory computer-readable media of claim 18, wherein the identified document is a contract that includes a plurality of clauses, and wherein the document content insights are associated with the plurality of clauses.

20. The one or more non-transitory computer-readable media of claim 19, wherein the document content insights identify a plurality of activities associated with the plurality of clauses.
